(19) United States
(12) Patent Application Publication
(10) Pub. No.: US 2023/0240474 A1
(43) Pub. Date: Aug. 3, 2023

(54) TOASTING TRAY FOR BUNS

(71) Applicant: Harana, LLC, San Ramon, CA (US)

(72) Inventor: Nigel Alexander Hayes-Davis, Toledo, OH (US)

(21) Appl. No.: 18/103,187

(22) Filed: Jan. 30, 2023

Related U.S. Application Data
(60) Provisional application No. 63/305,002, filed on Jan. 31, 2022.

(51) Int. Cl. A47J 37/08

(52) U.S. Cl. CPC A47J 37/0857

(57) ABSTRACT

A toasting tray for buns is shown and described. The toasting tray for buns comprises a ridge that is further comprised of an apex defined by the intersection of a first side surface and a second side surface. The toasting tray for buns also has a horizontal section connected at a lower end of said sides. A plurality of ribs protrudes above the apex, the first side surface, second side surface, and the horizontal section of the toasting tray for buns. Additionally, a plurality of elongated conducting elements are positioned inside of the ridge. The plurality of elongated conducting elements are in thermal contact with a downward facing surface of the toasting tray.

### CROSS-REFERENCE TO RELATED APPLICATIONS

This application claims the benefit of the filing date of U.S. Provisional Application Ser. No. 63/305,002 titled “TOASTING TRAY FOR BUNS” and filed Jan. 31, 2022, the subject matter of which is hereby incorporated by reference herein.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present invention relates to the field of foodstuffs, and more specifically to the field of toasting buns.

### BACKGROUND

Changes in family structure, including more working moms, single-parent and single-person households, means less time to cook and consume food at the traditional dinner table. The assembly of hot dog, hamburgers, bratwursts, and various sausages may often be a messy undertaking facilitating the need for a single apparatus capable of cooking hot dogs, hamburgers, and other foodstuffs in a simple, reliable, and clean manner. When cooking hot dogs, bratwurst, hamburgers, or other foodstuffs, users must open the bun widely to allow the bun to receive the food item. Nonetheless, issues arise because an open bun facilitates the leakage of condiments and other items of food out of the bun and often onto the consumer or their clothing. Additionally, it is often highly desirable that servings of food items such as hotdogs and hamburgers be cooked on a toasted bun, preferably one with grill marks. Generally, people do not have time to deal with the complicated process of toasting or grilling a bun in a clean manner and are thus forced to forgo either cleanliness or enjoying a toasted bun entirely.

Traditional manners of cooking buns with food are complicated, messy, and often fail to produce crispy buns with desirable grill marks. To toast the inner surfaces of a bun, the bun must usually be spread open to posture the bun flatly against a grill, baking sheet, or other hot surface. Issues arise when opening the bun for the purpose of toasting. Often, the hinged structure common in most buns is broken or structurally weakened such that it fails to support the placement of a food item or condiment when placed on a bun, thus resulting in further leakage of foodstuffs from the bun.

Various attempts at developing a robust toasting tray for buns have been made. For example, U.S. Pat. No. 8,714,077 (hereinafter “Roake”), issued May 6, 2014, discloses a bun heating and toasting apparatus having an elongated, inverted V-shaped bun support member formed of heat conductive material. Each bun support member, of the Roake bun heating and toasting apparatus, was arranged to support a partially opened hot dog bun or other bakery bun over an underlying heat source for heating and toasting of the interior surface of the supported bun. The bun support members of the Roake apparatus captured the heat from the heat source in an air space between the base of the apex and the interior cavity of the inverted V-shaped support members. The Roake bun heating and toasting apparatus complicated the process of preparing a meal such as a hotdog by requiring a separate apparatus to cook the food. Additionally, the Roake bun heating and toasting apparatus failed to produce aesthetically desirable grill marks favorable by a large number of consumers.

As a result, there exists a need for improvements over the prior art and more particularly for a simpler, more efficient way of allowing consumers to cook food requiring buns such as hotdogs and hamburgers quickly, cleanly, and more thoroughly.

### SUMMARY

A system and method toasting buns disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a toasting tray for buns is disclosed. The toasting tray for buns comprises a ridge that is further comprised of an apex defined by the intersection of a first side surface and a second side surface. The toasting tray for buns also has a horizontal section connected at a lower end of said sides. A plurality of ribs protrudes above the apex, the first side surface, second side surface, and the horizontal section of the toasting tray for buns. Additionally, a plurality of elongated conducting elements are positioned inside of the ridge. The plurality of elongated conducting elements are in thermal contact with a downward facing surface of the toasting tray.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1A is a first perspective view of the toasting tray for buns, according to an example embodiment;

FIG. 1B is a perspective view of the ridge, according to an example embodiment;

FIG. 2 is a distal side view of the toasting tray for buns with wedge shaped bun, according to an example embodiment;

FIG. 3 is a side view of the toasting tray for buns, according to an example embodiment;

FIG. 4 is a second perspective view of the toasting tray for buns, according to an example embodiment;

FIG. 5 is a distal side view of the toasting tray for buns having a second ridge, according to an example embodiment;

FIG. 6 is a top view of the toasting tray for buns, according to an example embodiment; and

FIG. 7 is a top view of a hinged bun having aesthetically pleasing markings caused by the toasting tray, according to an example embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a multifunctional toasting tray featuring an angled ridge for efficient toasting of the interior of buns. The toasting tray enables users to cook not only buns, but also food and condiments such as grilled onions or sausages. The elongated elements provide even heating along the surface of the tray. Additionally, the toasting tray for buns is provided with ridges such that buns toasted thereon have aesthetically desirable grill marks. The toasting tray may have a lip to catch crumbs and grease enabling users to cook buns and food without producing a mess. As a result, the disclosed embodiments produce a versatile and light weight toasting tray for buns that features a nonstick coating, reusable and environmentally friendly, dishwasher safe, durable, efficient heat retention and even heating of buns, and an ergonomically designed removable handle.

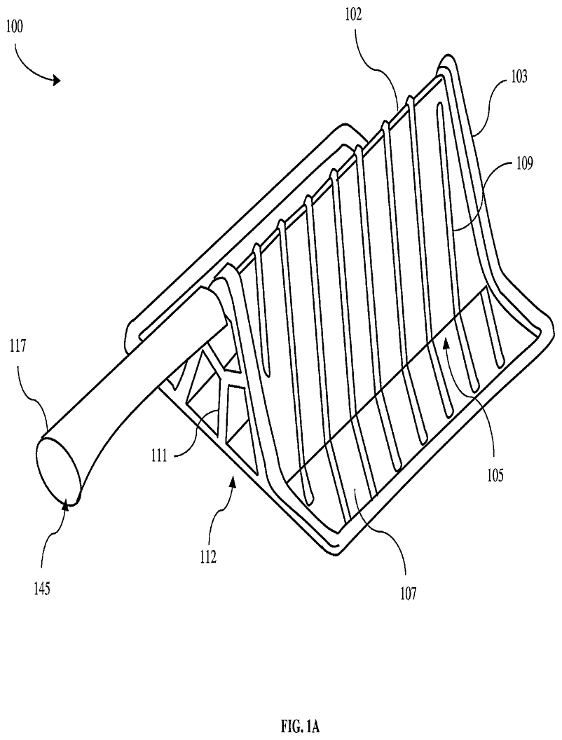

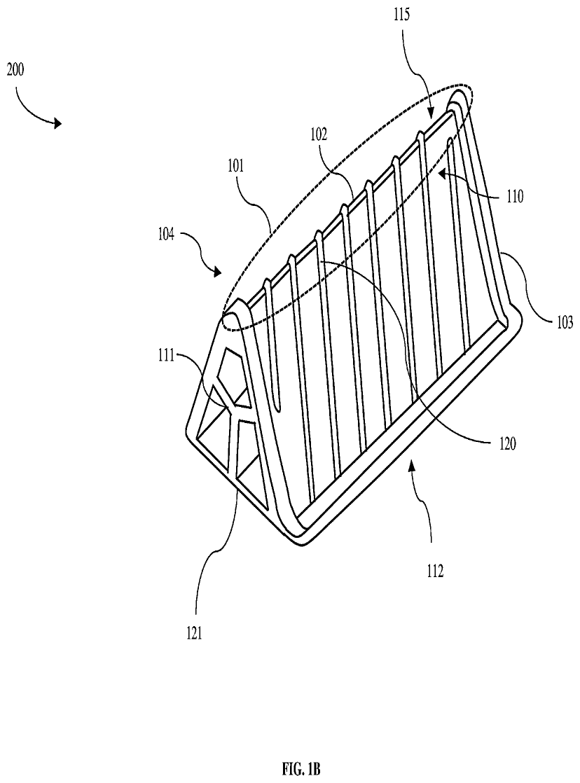

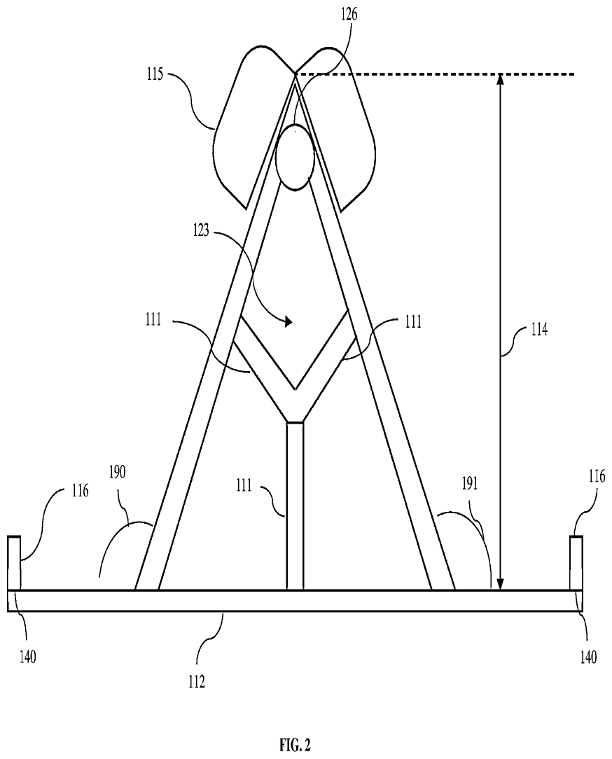

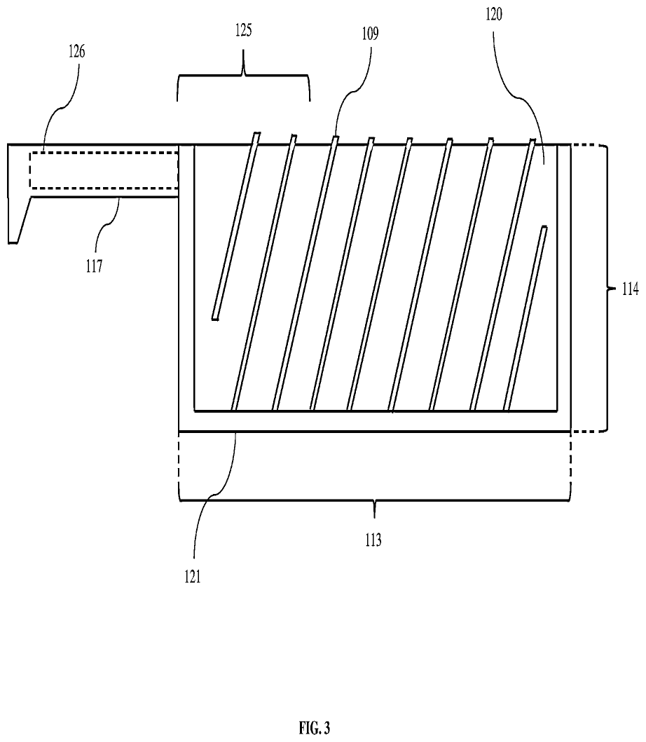

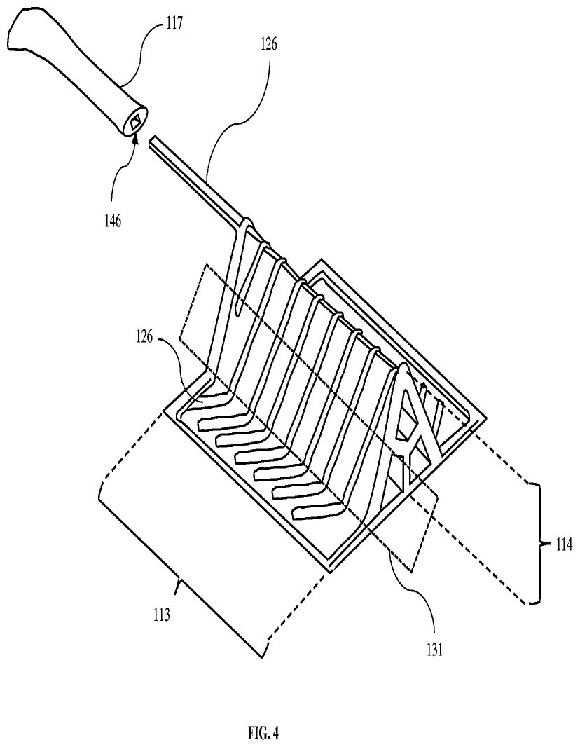

With reference now to FIG. 1A through FIG. 6. A first perspective view of a toasting tray 100 for buns, is illustrated according to an example embodiment. An example embodiment of a toasting tray is depicted having a ridge 101, a horizontal section 107, a plurality of ribs 109, and a plurality of elongated conducting elements 111. The ridge consists of an apex 102, a first side surface 103 located on a first side 110 of the apex 102, and a second side surface 104 located on a second side 115 of the apex 102. The horizontal section 107 connects to each side surface at a lower end 105 of each the first and second side surfaces. The plurality of ribs 109 protrude above or outward from the apex, the first and second side surfaces, and the horizontal section. In other words, the ribs extend above or beyond the outward facing surface of the toasting tray, such as the cooking surface. The plurality of elongated conducting elements 111 are positioned inside the ridge while in thermal contact with a downward facing surface 112 of the toasting tray.

The toasting tray 100, consists of a thermally conductive material. In some embodiments, the toasting tray is preferably comprised of cast iron. In some embodiments, the toasting tray is preferably covered with a nonstick material such as TEFLON™ to prevent the bun from sticking to the ridge. In other embodiments, the material of the toasting tray may include materials such as metals and metal alloys, ceramics, polymeric materials, and combinations thereof (e.g., composites) among other materials. Non-limiting examples of metals and metal alloys include carbon steel, stainless steel, aluminum, aluminum alloys, titanium, titanium alloys, among other metals and alloys. According to the example embodiment, the toasting tray 100 is planar having a hollow triangular prism extruding from the upward facing surface, however in other embodiments the toasting tray may be shaped differently. The toasting tray may take the shape of a circle, oval, ellipsoid, triangle, or any other polygonal structure. In some embodiments, the toasting tray preferably is in the shape of a rectangular or square container with a flat bottom.

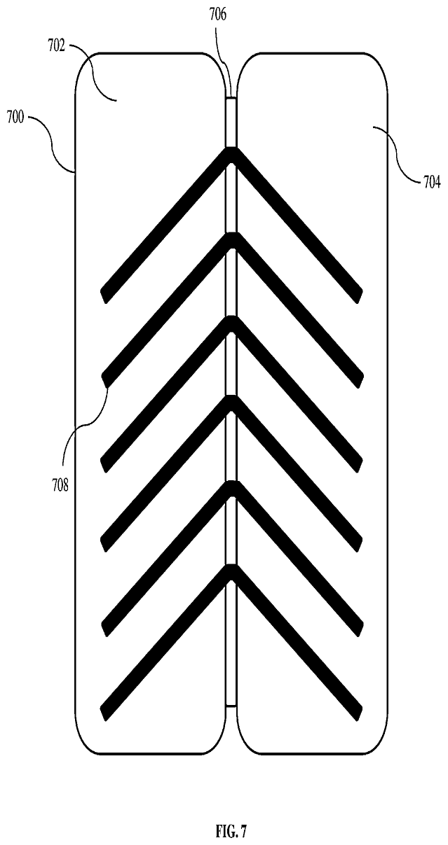

The toasting tray may be manufactured from a variety of different processes including via a CNC lathe, extrusion, casting (e.g., using a mold), welding, shearing, forging, and additive manufacturing, among others. It is understood that other materials and processes for the toasting tray may be used that are within the spirit and scope of the present invention. With a plurality of ribs 109 being extended from the apex 102 and onto the horizontal section 107, as shown in FIG. 7, any food placed on said section will possess aesthetically pleasing markings 708, as shown in FIG. 7. The aesthetically pleasing markings are grill markings left on the inside of the bun as a result of the heat transferred to the ribs on the cooking surface of the toasting tray.

The bun 700 is preferably wedge-shaped and/or has at least two halves connected. An example of a wedge-shaped bun is a hot dog bun of a loaf of bread that has been substantially sliced in half to create two connected halves. As discussed in the prior art, the difficulty with toasting a wedge-shaped bun lies in the elasticity of the connecting piece of bread acting as a hinge. When a wedge-shaped bun is flattened onto a grill or toasting tray, the crease 706 may tear causing the bun to divide into two separate pieces of bread. This may be problematic when the desire is for an intact wedge-shaped bun to be toasted and able to hold/enclose a food item such as a hot dog. The toasting tray provides a solution to this problem by having a ridge shaped as a triangular prism. This design allows a user to place the bun over the apex allowing both halves (first bun half 702 and second bun half 704) of the wedge-shaped bun to be in full contact with the thermal conducting material, without bending the crease past the point of breakage.

FIG. 1B is a second embodiment 200 of the toasting tray being substantially a cooking wedge without the horizontal sections of the toasting tray. The downward facing surface 112 is the thermal contact surface 121 that contacts the heat source. Ideally, the wedge-shaped bun support 115 comprises a material conducive for heating up to cook food, such as cast iron for example. The wedge-shaped bun support, in certain embodiments, may be a solid material with no internal channels or cavities. In other embodiments, the wedge-shaped bun support may have at least one cavity and/or channel and/or a plurality of conducting elements 111. The plurality of conducting elements transfer heat from the thermal contact surface 121 to the cooking surface 120. Additionally, in embodiments having at least one cavity and/or channel, the conducting elements act as a frame structure supporting the interior of the wedge shaped bun support and/or for directing the smoke and/or heat to exit the wedge-shaped bun support. The cooking surface includes the surface of the toasting tray in direct contact with a food item, which may include the plurality of ribs.

The ridge 101, as shown clearly in FIG. 1B, consists of an apex 102, a first side surface 103 on a first side 110 of the apex 102, and a second side surface 104 on a second side 115 of the apex 102. The ridge defines a height 114 such that an item may be elevated while cooking. The ridge 101, may be defined as the highest point or points of the device, more specifically the ridge may be defined as a narrow-raised strip, surface, and/or ledge on the topmost surface, peak, and/or apex of the toasting tray to support the bun. As illustrated, the toasting tray for buns may also have a ridge that has a first angle 190 as formed between the ridge and the first horizontal section 107. Additionally, the toasting tray for buns may also have a ridge that has a second angle 191 as formed between the ridge and the second horizontal section. Generally, the angle is between 90° to 180° degrees, however more ideally an acute angle between 100° to 145° degrees. The angle of the slope might be sloped to enable the bun to remain balanced in an upright position to optimize engagement with radiant heat energy.

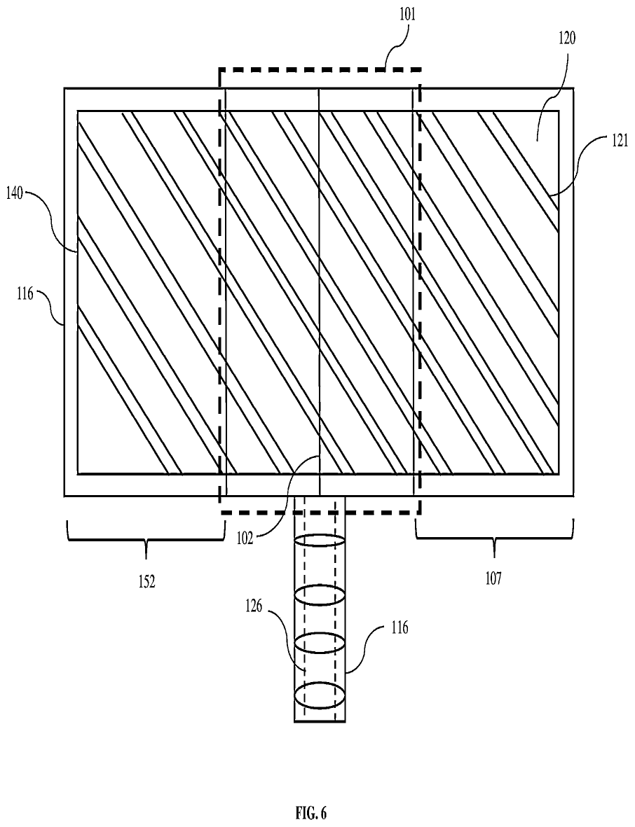

In some embodiments, the angle between the horizontal section and the ridge, as shown in FIG. 6, may be adjustable such that the operator may extend or limit the amount of space available on the horizontal section. An adjustable angle may also allow the operator to keep a bun from breaking. For example, in certain embodiments, the angle between the horizontal section and ridge may be roughly 110° degrees forming steeper side sections. Steep side sections allow the operator to place a bun at the apex without creasing and bending the bun hinge. As stated earlier, a common issue with toasting buns is the tendency of hinges breaking and failure to support placement of foods or condiments. Other angles may also be used and are within the spirit and the scope of the present invention.

The apex 102 is the upper most point of the toasting tray. For example, the apex may be pointed or rounded. The texture may be smooth or rough and the cross-sectional shape of the ovular, circular, or triangular. Other embodiments of the apex such that it is configured to toast the wedge of the bun are within the spirit and scope of the present invention. Ideally the apex is curved to conform to the wedge of the bun. The first side of the apex may be textured to grab and/or hold the bun more efficiently as it cooks on the ridge. In certain embodiments, there may be multiple apexes on a single ridge. In other embodiments there may multiple apexes on multiple rides. Multiple ridges may be useful when cooking and toasting a large amount of food at a single time. For example, if an operator brings the toasting tray for buns to a tailgate, it is likely that the whole tray will be full of food cooking. As the food cooks, the operator will likely need multiple buns to be toasted simultaneously for a complete meal to be served together. This situation creates a need for multiple ridges to be present on the toasting tray. In some embodiments the ridge 101 may be permanently positioned onto the toasting tray, in other embodiments the ridge may be removable. A removable ridge would allow the operator to easily clean and store each part of the toasting tray. In an embodiment having a removable ridge, the tray may have grooves and/or snaping elements for securing the ridge onto the tray. Other types of securing elements may also be used and are within the spirit and scope of the present invention.

The first side surface 103 and second side surface 104 are planar, each having a width 113 designed to allow a bun to rest on. The first side surface, second side surface, and an opening 122 at the apex form a wedge-shaped bun support 115. In some embodiments the first and second side surface may include shelf-like tabs for buns without hinges to be placed. These tabs may be adjustable and removable to better fit the specific layout the operator needs at the time of use. For example, if an operator desires to toast small hamburger buns used for sliders, there is a need for shelves/tabs to support multiple buns at a time. This feature would create a more efficient process for toasting a variety of food items. As mentioned above, the ridge may be adjustable allowing the first side surface and second side surface to also be adjustable. The angle 190 of the side surfaces is important to consider when spreading the hinged bun across the apex.

The toasting tray contains a horizontal section 107 connected at a lower end 105 of each first and second side surface. In operation, the horizontal section 107 may be used to cook condiments such as chopped onions. Furthermore, in operation an item of food such as ribs, chicken, steak, hamburger patties, or hotdogs may be cooked on either the first or second horizontal surfaces. Meanwhile, a hinged bun such as a hotdog or hamburger bun may be placed on the ridge such that both sides of the bun are uniformly heated. Various embodiments of the toasting tray for buns may only have a first horizontal section instead of a first and second. As mentioned previously, the horizontal sections may be used for any food item. With a plurality of ribs 109 being extended from the apex 102 and onto the horizontal section 107, any food placed on said section will possess aesthetically pleasing grill marks. For example, if the operator is cooking hamburger patties, asparagus, and toasting bread, he or she may do so all on the toasting tray for buns. The meat and vegetables can be cooked on the horizontal section, while the bread and buns may be toasted on the first and second side surfaces. In some embodiments the horizontal section may span thirty-six (36) inches, creating a large surface for cooking a variety of foods. The horizontal sections acting as dripping trays also help make the process compact and convenient when grilling or toasting different food items.

A lower end 105 of each side surface may connect to a horizontal surface. This creates a continuous plate/tray beginning from the apex and ending at the perimeter edge 140 of the tray. In some embodiments the lower end may be curved, in other embodiments the lower end may be flat. The lower end of the side surface may also include a grove, hinge, roller, etc. For example, in some embodiments the lower end of the side surface may include a hinge connecting to the horizontal section. This hinge would allow for easy and compact storage of the toasting tray and ridge. In another embodiment, the lower end of the side surface may contain a groove used for joining the side surface and horizontal surface.

The plurality of ribs 109 protrude above the apex 102, the first side surface 103, and the second side surface 104. Generally, protruding may be defined as to extend beyond or above a surface. The ribs provide a strengthening means reinforcing the rigidity of the tray. In operation, when the toasting tray is hot, the ribs transfer heat directly to discrete portions of the bun or food item creating aesthetically desirable cooking marks on an item of food placed and heated upon the toasting tray. In some embodiments the ribs may be shaped differently depending on what the operator desires the cooking marks to appear as. For example, the ribs may be in the shape of a state, such as Oklahoma, a sports team, or a company brand. The plurality of ribs comprises thermally conductive material and are configured for providing aesthetically pleasing markings on buns being toasted on the tray.

As shown in FIG. 1B, the ridge 101 has an interior defining at least one conducting element 111. The plurality of elongated conducting elements are generally in thermal contact with a downward facing surface 112 of the toasting tray for buns. The elongated conducting elements, and either the ridge and/or downward facing surface of the toasting tray for buns together define an interior cavity 123 below the ridge. In operation, when heat is applied to the bottom surface of the toasting tray, heat from the underlying heat source is permitted to flow directly up into the interior cavity. Heat flowing up in the interior cavities is transferred to the ridge to facilitate uniform heating of a bun placed upon the ridge.

In some embodiments, the plurality of elongated conducting elements 111 are preferably positioned adjacent to each other such that a thermally conductive junction is formed. In other embodiments, the elongated conducting elements may be arranged differently. For example, the elements may be shaped differently in size and thickness. The orientation of the elongated conducting elements may resemble a sports team logo, company logo, or any preferred custom design.

Alternatively, some embodiments of the toasting tray may feature the plurality of elongated conducting elements that are not in thermal contact with a downward facing surface 112 such that the plurality of cavities 123 within the ridge 101 directly expose the plurality of elongated conducting elements to a heating unit such as a conventional gas, electric, or microwave oven, or upon a range top grill, fire pit, Bunsen burner, or other item capable of generating heat suitable to cook food. In some embodiments the plurality of elongated conducting elements are formed of a heat conductive material such as metals and metal alloys, polymeric materials, glass, and combinations thereof (e.g., composites) among other materials. Non-limiting examples of metals and metal alloys include carbon steel, stainless steel, aluminum, aluminum alloys, titanium, titanium alloys, among other metals and alloys. In some embodiments, the plurality of elongated conducting elements are preferably comprised of cast iron, however other materials may be used and are within the spirit and the scope of the present invention.

The toasting tray 100 consists of a thermally conductive material which allows heat energy to be transferred from the source, such as a grill, to the food laying on the toasting tray. The toasting tray consists of a conducting element thermally connecting the cooking surface to the thermal contact surface. Common materials may include metals and metal alloys, polymeric materials, glass and combinations thereof (e.g., composites) among other materials. FIG. 7 depicts the aesthetically pleasing markings formed from the ribs being made from a thermally conductive material such as the above referenced. Aesthetically pleasing markings may be defined as grill markings or markings left on the bun from the cooking surface of the toasting tray. The markings are caused by the plurality of ribs.

The toasting tray for buns having a removable cover 117 located at a proximal end of the ridge 101. Alternatively, some embodiments may have a removable cover located at either the first horizontal section 107 or a second horizontal section 152, as shown in FIG. 7. Alternatively, some embodiments may have a removable cover located at the apex 102 of the ridge 101. Other embodiments have the removable cover located preferably at the proximal end or the distal end of ridge 101. The removable cover may vary in shape, for example the shape of a handle, some may take the form of a different shape or design to better fit the operator's hand. In operation, when the toasting tray for buns is being used to cook a food item, a user will grasp the removable cover to avoid burning themselves from the otherwise hot toasting tray for buns.

The removable cover 117 consists of a non-thermally conductive material. The removable cover is a tubular shaped body having a first closed end 145 and a second open end 146. The removable cover is designed for covering the handle. The removable cover 117 may also have a second end that is either closed or defining a second open end of the removable cover. In some embodiments, the removable cover may be at least two (2) inches but not greater than twenty four (24) inches long as measured from the opening to the second closed end of the removable cover. In some embodiments, the removable cover is preferably comprised of an insulating material. The removable cover may be comprised of rubber, polymeric materials such as plastic, polyvinyl chloride (PVC) plastic, vinyl, silicone etc. The removable cover may be made from a thick material with a design or texture imprinted onto said cover. The non-thermally conductive material may be made from plastic, rubber, thermally insulated fabric, or Kevlar. Other materials may also be used and are within the spirit and scope of the present invention.

The toasting tray includes a lip 116, located on a perimeter edge of the toasting tray. In operation, the lip may function to prevent grease, crumbs, or other food items from falling off the toasting tray. The lip may vary in size and shape. For example, in some embodiments the lip may have a rounded edge and may extend several inches giving the operator larger area to place foods. In other embodiments the lip may have a sharp edge for burning sharp straight brill marks into a variety of foods. For example, the operator may use the ribs for parallel grill marks, then manually use a sharp-edged lip to burn a specific symbol or such into the food. The perimeter 140 of the toasting tray may be defined as where the lip begins or where the horizontal section ends.

The horizontal section width 113 is configured to allow a hamburger type bun or food item such as ribs to rest thereon. In some embodiments, the toasting tray width ranges from no less than six (6) inches to no greater than thirty six (36) inches. However in other embodiments the width may range greater than thirty six inches. For example if the toasting tray is to be used for food preparation for large crowds the width may need to be extended to prepare large amounts of food. As displayed, the toasting tray has a ridge height. Generally, the ridge of the toasting tray has a ridge height 114 defined by the distance between the bottom surface and apex. The ridge height may be such that it is suitable to toast the interior region of a hotdog, hamburger, or other bun. In some embodiments, the ridge height is preferably at least two (2) inches but no greater than twenty-four (24) inches. Where only one hot dog or hamburger bun is provided for, one may use two single half bun utensils and mate the buns from them, and it may produce a completely enfolding hinged bun in a singular forming utensil. The dimensions of the at least one tray maximize the cooking area of the device to cook numerous food items. The horizontal sections extending from the bottom section of the toasting tray additionally provide a drip tray to catch oils and food particles that may drop from food items cooking on the apex of the wedge of the toasting tray. Ideally, the dimensions of the device are configured to conform to standard grills and stove tops; however, in certain embodiments, the device may be larger to conform to a large cooking area and, as such, should not be construed to limit this invention to the dimensions herein.

Wedge shaped bun support 115 includes an opening 122 at the apex 102 between the first side surface and the second side surface. The wedge-shaped bun support includes a cooking surface 120 and a thermal contact surface 121. The wedge-shaped bun support having an apex, a first ridge on a first side proximate to the apex, a second ridge on a side proximate to the apex, and an opening 122 on the apex 102 between the first ridge and the second ridge where the opening extends to an interior cavity 123. The interior cavity acts as a channel for heat flow within the toasting tray for buns.

The cooking surface 120 having a plurality of ribs may or may not be in contact with the food item. The cooking surface may not directly contact the food placed on the tray. For example, stiff foods such as asparagus will likely lay across the plurality of ribs while hovering above the cooking surface. The cooking surface may be defined as any part of the device in which food is being prepared on, more specifically a cooking surface is defined as a flat surface on which you can do things such as prepare food. The cooking surface may be made from a variety of materials such as metals and metal alloys, ceramics, polymeric materials, and combinations thereof (e.g., composites) among other materials. Non-limiting examples of metals and metal alloys include carbon steel, stainless steel, aluminum, aluminum alloys, titanium, titanium alloys, among other metals and alloys. One of the most common materials used in cookware is TEFLON™.

The thermal contact surface 121, being the plurality of ribs, is what creates the aesthetically pleasing grill marks on the food being toasted or cooked. The thermal contact surface may be defined as the part of the device that directly contacts a heat source, such as a hot plate of an oven or a grill top over a fire. The thermal contact surface directly contacts the heat and transfers the heat throughout the toasting tray. The thermal contact surfaces may appear differently in other embodiments. The surfaces may be flat and smooth for uniform grilling, or the surfaces may have texture so that the food placed on the surface forms spotty or curved grill marks. In some embodiments, a toasting tray may have a traditional design such as the straight grill grate look. In other embodiments, the contact surface may have the plurality of ribs oriented such that a logo or specific shape is resembled.

The opening 122 at the apex 102 extends to an interior cavity 123 of the wedge-shaped bun support. In embodiments having a second ridge, the toasting tray for buns may have a gap or opening between the first ridge 101 and second ridge 150 defined by the distance between the first apex 102 and the second apex 151. In operation, a bun may be placed in an open position resting upon both the first ridge 101 and second ridge 150 such that a hinged region of the bun is exposed to the ridge gap ridge gap enabling the heat to radiate up into the hinged region of a bun effectively cooking the interior of the bun. In some embodiments, the length of the opening/gap may be at least 1/48^{th} of an inch and ½ inch.

The toasting tray consists of an interior cavity 123 within the wedge-shaped bun support where at least one interior cavity acts as a channel extending through the wedge-shaped bun support from an open first end of the wedge-shaped bun support to an open second end of the wedge-shaped bun support. In some embodiments there may be a single internal cavity wherein other embodiments there may be multiple cavities. The importance of the interior cavity lies in the heat transfer happening throughout the toasting tray. Having the apex opening lead to at least one cavity, allows an operator to place a wedge-shaped bun directly over the apex leaving the creased hinged area of the bun out of direct contact with the tray. The interior cavity allows the heat to rise up from the downward facing surface consisting of a thermally conductive material.

Because the heat contacts the crease of the wedge-shaped bun, the crease will cook and keep its structural integrity while the larger halves of the bun toast on the plurality of ribs on each side of the apex. The interior cavity having at least one channel 123, extends through the wedge-shaped bun support from an open first end of the wedge-shaped bun support to an open second end of the wedge-shaped bun support. This channel is used for heat transfer. As mentioned above, a channel provides a passageway for heat energy to travel through. In some embodiments, the channel may be tubular wherein other embodiments the channel may be triangular.

An elongated-shaped element 126 extends from a rear side of the toasting tray and is designed for being grasped by a user as a handle. This handle 126 may be in attachment with an end portion 125 of the toasting tray 100. The handle element may be configured to receive a removable cover at an end of the removable cover that defines an opening. In some embodiments the handle may be shaped to configure a user's hand, in other embodiments the handle may have a hole to be used for hanging storage.

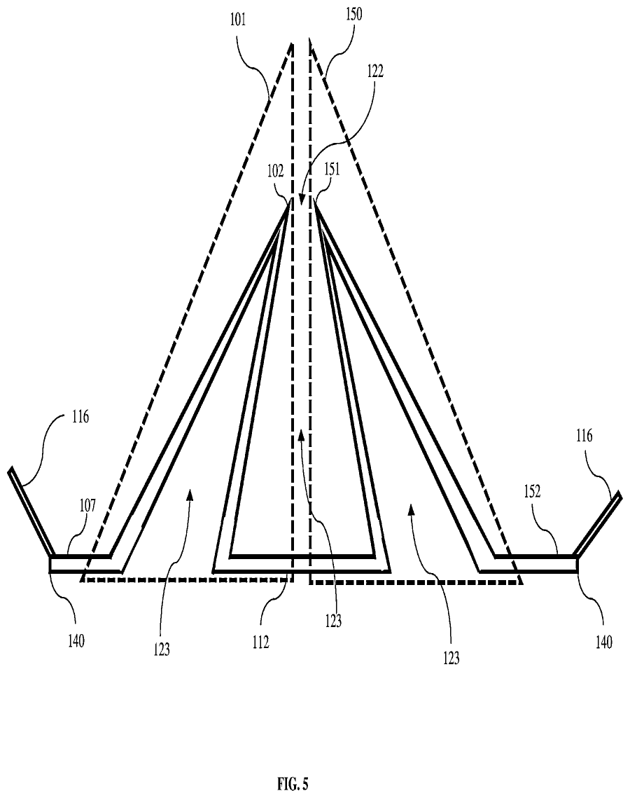

As illustrated in FIG. 5, an example of an alternative embodiment of a toasting tray for buns is shown. The toasting tray for buns may have a bottom surface 112 connecting a first ridge 101 having a first apex 102 to a second ridge 150 having a second apex 151. The first and second ridges (101, 150) may each define a respective cavity. Additionally, alternative embodiments of the toasting tray for buns may also have a first horizontal section 107 connected to the first ridge 101 and may have a second horizontal section 152 connected to a second ridge 150. As mentioned above, this example embodiment provides a channel 123 for direct heat flow from the bottom surface up through the apex opening 122. This allows for a hinged bun to be placed over the apex opening, giving the hinged section of the bun heat for toasting while not directly burning the bread. In other embodiments, the tray may be designed to have several other ridges and apexes oriented differently.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A toasting tray for buns comprising:
a. a ridge having an apex, a first side surface on a first side of the apex and a second side surface on a second side of the apex;
b. a horizontal section connected at a lower end of each of the first side surface and the second side surface;
c. a plurality of ribs protruding above the apex, the first side surface, the second side surface and the horizontal section; and
d. a plurality of elongated conducting elements positioned inside the ridge in thermal contact with a downward facing surface of the toasting tray.

2. The toasting tray of claim 1, wherein the toasting tray comprises a thermally conductive material.

3. The toasting tray of claim 2, wherein the first side surface and the second side surface are planar.

4. The toasting tray of claim 3, wherein the first side surface and the second side surface each define a width configured to allow a bun to rest thereon.

5. The toasting tray of claim 4, wherein the ridge defines a height such an item may be cooked.

6. The toasting tray of claim 5 wherein a wedge-shaped bun support comprises an opening at the apex between the first side surface and the second side surface; wherein the opening extends to an interior cavity of the wedge-shaped bun support.

7. The toasting tray of claim 6, wherein the plurality of ribs comprises the thermally conductive material and are configured for providing aesthetically pleasing markings on buns being toasted on the toasting tray.

8. The toasting tray of claim 7, wherein the toasting tray comprises a lip at perimeter of the toasting tray.

9. The toasting tray of claim 8, wherein an elongated-shaped element extends from a rear side of the toasting tray and is configured for being grasped by a user as a handle.

10. The toasting tray of claim 9, wherein the toasting tray comprises a removable cover comprising a non-thermally conductive material; wherein the removable cover is a tubular shaped body having a first closed end and a second open end; and wherein the removable cover is configured for covering the handle, and wherein.

11. A toasting tray for buns comprising:
a. a wedge-shaped bun support comprising a cooking surface and a thermal contact surface.

12. The toasting tray of claim 11 wherein the wedge-shaped bun support comprises:
a. an apex;
b. a first ridge on a first side of the wedge-shaped bun support proximate to the apex;
c. a second ridge on a side of the wedge-shaped bun support proximate to the apex; and
d. an opening on the apex between the first ridge and the second ridge wherein the opening extends to an interior cavity of the wedge-shaped bun support.

13. The toasting tray of claim 11 comprising a plurality of ribs on the cooking surface.

14. The toasting tray of claim 11 comprising at least one conducting element thermally connecting the cooking surface to the thermal contact surface.

15. The toasting tray of claim 11 comprising at least one tray proximate to a bottom section of the wedge-shaped bun support.

16. The toasting tray of claim 11 comprising a lip on a perimeter edge of the toasting tray.

17. The toasting tray of claim 11 comprising a handle in attachment with an end portion of the toasting tray.

18. A toasting tray for buns comprising:
a. a wedge-shaped bun support comprising a cooking surface and a thermal contact surface;
b. a plurality of ribs on the cooking surface;
c. at least one cavity within the wedge-shaped bun support;
d. at least one conducting element thermally connecting the cooking surface to the thermal contact surface; and
e. at least one tray proximate to a bottom section of the wedge-shaped bun support.

19. The toasting tray of claim 18 wherein the at least one cavity is at least one channel extending through the wedge-shaped bun support from an open first end of the wedge-shaped bun support to an open second end of the wedge-shaped bun support.

20. The toasting tray of claim 18 further comprising an opening at an apex of the wedge-shaped bun support wherein the opening extends to the at least one cavity within the wedge-shaped bun support.
